(19) United States
(12) Patent Application Publication
(10) Pub. No.: US 2014/0262679 A1
(43) Pub. Date: Sep. 18, 2014

(54) COIN ACCEPTOR WITH A LIMITER MECHANISM FOR ANTI-THEFT PROTECTION

(71) Applicant: INTERNATIONAL CURRENCY TECHNOLOGIES CORPORATION, Taipei (TW)

(72) Inventors: Yung-Hao CHIANG, Taipei (TW); Chia-Hung HU, Taipei (TW); Fong-Cheng WEI, Taipei (TW)

(73) Assignee: INTERNATIONAL CURRENCY TECHNOLOGIES CORPORATION, Taipei (TW)

(21) Appl. No.: 13/800,546

(22) Filed: Mar. 13, 2013

(51) Int. Cl. G07D 11/00; G07D 5/08

(52) U.S. Cl. CPC G07D 11/0018; G07D 5/08
USPC 194/302; 194/344

(57) ABSTRACT

A coin acceptor includes a coin acceptor main unit including a first holder shell and second holder shell pivotally coupled together, and a face panel including a panel body fastened to the front side of the first holder shell and a limiter mechanism mounted at the back side of the panel body and adjustable between a constraint position and a release position to control the biasing angle of the second holder shell relative to the first holder shell, preventing an evil person from inserting a screwdriver, pry or any other tool through a coin insertion slot or coin-return slot of the face panel into the inside of the coin acceptor main unit to damage the internal structure.

### BACKGROUND OF THE INVENTION

1. Field of the Invention

The present invention relates to coin acceptor technology and more particularly, to a coin acceptor with a limiter mechanism for anti-theft protection, which prevents an evil person from inserting a screwdriver, pry or any other tool through the coin insertion slot or coin-return slot into the inside of the coin acceptor main unit to damage the internal structure.

2. Description of the Related Art

Following fast development of social civilization and technology, people accelerate their pace of life and demand a better quality of life. In consequence, various automatic vending machines are used everywhere to sell different products without serviceman, bringing convenience to people and helping suppliers save much labor cost. Following increasing of selling items, new automatic vending machines with added functions are created.

Further, regular automatic vending machines and game machines commonly use a coin acceptor for receiving coins so that a consumer can insert coins into an automatic vending machine or game machine to purchase commodities or to play games. The coin receiver of a coin-operated machine generally comprises a sensor module for recognizing the authenticity and value of every inserted coin. Because different coins or tokens may be used in different countries or different amusement parks and because different coins/tokens have different sizes and values, a sensor module must be able to recognize the authenticity and values of different coins/tokens. The recognition accuracy of the sensor module is relevant to the subsistence and profit of the business owner and the rights of consumers.

However, automatic vending machines and game machines are commonly installed in stations, airports, schools, street corners, sightseeing spots, or other indoor or outdoor public places that are crowded with people. However, if an automatic vending machine or game machine is installed in a remote place or outdoor area, evil persons can insert a screwdriver, pry or any other tool through the coin insertion slot or coin-return slot into the inside of the coin acceptor main unit to damage the internal structure and to take coins from the machine. It takes much time and labor to repair or troubleshoot an automatic vending machine or game machine, increasing business running cost.

Therefore, it is desirable to provide a coin acceptor that eliminates the aforesaid problems.

### SUMMARY OF THE INVENTION

The present invention has been accomplished under the circumstances in view. It is therefore one object of the present invention to provide a coin acceptor, which provides a limiter mechanism to prevent an evil person from inserting a screwdriver, pry or any other tool through the coin insertion slot or coin-return slot into the inside of the coin acceptor main unit to damage the internal structure.

To achieve this and other objects of the present invention, a coin acceptor comprises a face panel and a coin acceptor main unit. The coin acceptor main unit comprises a first holder shell, a second holder shell, a pivot mechanism pivotally coupling the rear side of the second holder shell to the rear side of the first holder shell, a coin passage defined between the first holder shell and the second holder shell, and coin outlet located at the rear side of the coin passage, a coin-return passage located at the front side of the coin outlet. The face panel comprises a panel body fastened to the front side of the first holder shell, a coin insertion slot kept in communication with the coin passage, a coin-return slot kept in communication with the coin-return passage, and a limiter mechanism mounted at the back side of the panel body and adjustable between a constraint position and a release position to control the biasing angle of the second holder shell relative to the first holder shell, preventing an evil person from inserting a screwdriver, pry or any other tool through a coin insertion slot or coin-return slot of the face panel into the inside of the coin acceptor main unit to damage the internal structure and prolonging the lifespan of the coin acceptor.

Further, the second holder shell of the coin acceptor main unit comprises a bottom bearing portion, and an open space defined above said bottom bearing portion. Further, the limiter mechanism of the face panel comprises a longitudinal guide rail affixed to the back side of the panel body, and a sliding block mounted on and movable along the longitudinal guide rail between the constraint position and the release position. The sliding block comprises a protruding stop flange backwardly extended from one lateral side thereof. The protruding stop flange is suspended in the open space of the second holder shell without hindering the biasing of the second holder shell relative to the first holder shell when the limiter mechanism is in the release position. The protruding stop flange is stopped against the bottom bearing portion of the second holder shell to limit the biasing angle of the second holder shell relative to the first holder shell when the limiter mechanism is in the constraint position.

Further, the longitudinal guide rail comprises a flat narrow guide rail plate located at the front side thereof, and a plurality of raised portions located upper and lower sides of the outer edge of the flat narrow guide rail plate. The sliding block comprises a sliding slot coupled to and movable along the longitudinal guide rail, a sliding groove longitudinally located in an inner side of the sliding slot and coupled to and movable along the flat narrow guide rail plate, and a plurality of retaining holes located in the sliding groove for selectively receiving the raised portions at the lower or upper side of the outer edge of the flat narrow guide rail plate to keep the sliding block in the constraint position or the release position.

### BRIEF DESCRIPTION OF THE DRAWINGS

FIG. 1 is an elevational view of a coin acceptor in accordance with the present invention.

FIG. 2 is an exploded view of the coin acceptor in accordance with the present invention.

FIG. 3 corresponds to FIG. 2 when viewed from another angle.

FIG. 4 is an enlarged view of Part A of FIG. 3.

FIG. 5 is a side view of the coin acceptor in accordance with the present invention.

FIG. 6 is a schematic oblique top elevation, illustrating the second holder shell biased relative to the first holder shell for coin return during a troubleshooting operation.

FIG. 7 is a top view of FIG. 6.

FIG. 8 is a schematic side view of the present invention, illustrating adjustment of limiter mechanism toward the release position.

FIG. 9 is an oblique top elevation of the present invention, illustrating the limiter mechanism adjusted to the release position.

### DETAILED DESCRIPTION OF THE PREFERRED EMBODIMENT

Referring to FIGS. 1-5, a coin acceptor in accordance with the present invention is shown comprising a coin acceptor main unit 1 and a face panel 2.

The coin acceptor main unit 1 comprises a first holder shell 11 and a second holder shell 12 attached together side to side, a coin passage 10 defined between the first holder shell 11 and the second holder shell 12 for the passing of coins 3, a coin outlet 101 defined between the first holder shell 11 and the second holder shell 12 in communication with the rear side of the coin passage 10, a coin-return passage 102 defined between the first holder shell 11 and the second holder shell 12 in communication with the rear side of the coin passage 10 and at a front side relative to the coin outlet 101 for returning coins 3, a coin validator 13, which comprises a plurality of circuit boards 130 respectively mounted in the first holder shell 11 and the second holder shell 12 and a plurality of induction coils 131 and optical identification devices 132 installed in the circuit boards 130 and adapted to identify the authenticity and value of coins 3, a pivoting mechanism 14, which comprises a pivot shaft 141 inserted through pivot holder shells (not shown) at the rear side of the first holder shell 11 and pivot holder shells (not shown) at the rear side of the second holder shell 12 to pivotally connect the first holder shell 11 and the second holder shell 12 together and a torsional spring 142 mounted around the pivot shaft 141 and stopped with two opposite ends thereof against the first holder shell 11 and the second holder shell 12 to impart a pressure to the second holder shell 12 toward the first holder shell 11 and to hold the first holder shell 11 and the second holder shell 12 in a close position, an electromagnetic valve 151 mounted in the second holder shell 12, a gate 15 movable by the electromagnetic valve 151 to close/open the coin outlet 101, a first cover member 111 covering the first holder shell 11, and at least one, for example, two second cover members 122 covering the second holder shell 12. Further, the second holder shell 12 has a substantially U-shaped profile, defining a bottom bearing portion 121 and an open space 120 above the bottom bearing portion 121.

The face panel 2 comprises a panel body 21, a coin insertion slot 211 located in the panel body 21 for the insertion of coins 3, a coin-return slot 212 located in the panel body 21 and spaced below the coin insertion slot 211, an accommodation chamber 213 defined in the panel body 21 between the coin insertion slot 211 and the coin-return slot 212, a through hole 2130 located in the accommodation chamber 213, a coin-return button 22 mounted in the accommodation chamber 213 and operable to let an inserted coin 3 return to the coin-return slot 212 and having a plunger 221 inserted through the through hole 2130, an elastic member, for example, coil spring 222 mounted around the plunger 221 of the coin-return button 22 and stopped between the coin-return button 22 and the bottom wall of the accommodation chamber 213, a back partition plate 214 perpendicularly backwardly extended from the back wall of the panel body 21 adjacent to one side of the coin insertion slot 211. Further, the coin-return button 22 comprises the plunger 221, and a limiter mechanism 23 mounted at the back side of the panel body 21.

The limiter mechanism 23 comprises a longitudinal guide rail 231 affixed to the back side of the panel body 21, and a sliding block 232 mounted on and movable along the longitudinal guide rail 231. The longitudinal guide rail 231 comprises two coupling grooves 2311 located at two opposite lateral sides thereof and extending along the length, a flat narrow guide rail plate 2312 located at the front side thereof on the middle between the two coupling grooves 2311, and a plurality of raised portions 2313 located the outer edge of the flat narrow guide rail plate 2312 at lower and upper sides. The sliding block 232 comprises a sliding slot 2320 coupled to and movable along the longitudinal guide rail 231, two coupling flanges 2321 respectively coupled to the coupling grooves 2311 of the longitudinal guide rail 231, a sliding groove 2322 longitudinally located in the inner side of the sliding slot 2320 and coupled to and movable along the flat narrow guide rail plate 2312, a plurality of retaining holes 2323 located in the sliding groove 2322 for receiving the raised portions 2313 at the lower or upper side of the outer edge of the flat narrow guide rail plate 2312, and a protruding stop flange 2324 backwardly extended from one lateral side thereof remote from the two coupling flanges 2321.

When assembling the coin acceptor, fasten the panel body 21 of the face panel 2 to the front side of the first holder shell 11 and second holder shell 12 of the coin acceptor main unit 1 by screws or any other fastening means to keep the coin insertion slot 211 of the panel body 21 in communication with the coin passage 10 and coin-return passage 102 of the coin acceptor main unit 1 and to keep the back partition plate 214 in between the first holder shell 11 and second holder shell 12 of the coin acceptor main unit 1 for guiding coins 3 from the coin insertion slot 211 into the coin passage 10. At this time, the plunger 221 of the coin-return button 22 is kept in proximity to the front side of the first holder shell 11 and second holder shell 12 of the coin acceptor main unit 1 and the sliding block 232 of the limiter mechanism 23 is suspending in the rotating path of the second holder shell 12. Thus, the coin acceptor is well assembled.

The coin acceptor is practical for used in an automatic vending machine, game machine, or any of a variety of consumer systems that sell commodities or provide services. After the coin acceptor is installed in the housing of an automatic vending machine, game machine of consumer system, the face panel 2 is positioned in the front side of the housing of the automatic vending machine, game machine of consumer system, and the circuit boards 130 of the coin validator 13 are electrically coupled to the control circuit of the automatic vending machine, game machine of consumer system for the transmission of data and power supply, enabling the automatic vending machine, game machine of consumer system to validate the authenticity and value of inserted coins or tokens, to receive validated coins or tokens, or to return coins or tokens.

When a user inserted a coin 3 into the coin insertion slot 211 in the panel body 21 of the face panel 2, the inserted coin runs along the coin passage 10 to the coin validator 13 where the induction coils 131 and the optical identification devices 132 detect the authenticity and value of the coin 3. If the inserted coin 3 is a counterfeit coin, it will fall to the gate 15 and then run along the coin-return passage 102 to the coin-return slot 212. On the contrary, if the inserted coin 3 is a true coin, the electromagnetic valve 151 will be started to move the gate 15, opening the coin outlet 101 for letting the inserted coin 3 fall to the coin outlet 101 toward a coin box (not shown).

Referring to FIGS. 6 and 7, in case an inserted coin 3 is jammed in the coin passage 10 of the coin acceptor main unit 1, the user can press the coin-return button 22 to force the plunger 221 against the front side of the second holder shell 12, deforming the coil spring 222 and forcing the second holder shell 12 to turn about the pivot shaft 141 relative to the first holder shell 11. At this time, the inserted coin 3 drops from the coin passage 10 to the coin-return passage 102 toward the coin-return slot 212. Thus, the invention can troubleshoot any coin jam error (due to insertion of multiple coins at a time, new coin recognition inability, or contaminated coin).

Further, the sliding block 232 of the limiter mechanism 23 can be moved to a predetermined constraint position near the bottom side of the longitudinal guide rail 231 to keep the protruding stop flange 2324 in the biasing path of the second holder shell 12, limiting the turning angle of the second holder shell 12 relative to the first holder shell 11 while maintaining the coin return function, preventing an evil person from inserting a screwdriver, pry or any other tool through the coin insertion slot 211 of the face panel 2 or the coin-return slot 212 into the inside of the coin acceptor main unit 1 to damage the internal structure. Thus, troubleshooting related time and labor cost and business loss can be significantly reduced, and the lifespan of the machine can be greatly prolonged.

Referring to FIGS. 8 and 9, the limiter mechanism 23 is movable between the aforesaid constraint position and a release position. When adjusting the limiter mechanism 23 from the aforesaid constraint position to the release position, push the sliding block 232 upwards to move the two coupling flanges 2321 of the sliding block 232 along the coupling grooves 2311 of the longitudinal guide rail 231 and the sliding groove 2322 along the flat narrow guide rail plate 2312. When reached the release position, the retaining holes 2323 in the sliding groove 2322 of the sliding block 232 are respectively forced into engagement the raised portions 2313 at the upper side of the outer edge of the flat narrow guide rail plate 2312. At this time, the user's hand can sense accurate positioning of the sliding block 232, and the protruding stop flange 2324 of the sliding block 232 is held in the open space 120 above the bottom bearing portion 121 of the second holder shell 12. Thus, when biasing the second holder shell 12 relative to the first holder shell 11, the protruding stop flange 2324 of the sliding block 232 will not hinder the bottom bearing portion 121 of the second holder shell 12, facilitating cleaning and maintenance works.

In conclusion, the invention provides a coin acceptor, which comprises a coin acceptor main unit 1, which comprises a first holder shell 11 and second holder shell 12 that are pivotally coupled together, and a face panel 2, which comprises a panel body 21 fastened to the front side of the first holder shell 11 and a limiter mechanism 23 that comprises a longitudinal guide rail 231 and a sliding block 232 coupled to and movable along the longitudinal guide rail 231 between a constraint position and a release position to control the biasing angle of the second holder shell 12 relative to the first holder shell 11, preventing an evil person from inserting a screwdriver, pry or any other tool through a coin insertion slot 211 or coin-return slot 212 of the face panel 2 into the inside of the coin acceptor main unit 1 to damage the internal structure.

It is to be noted that the limiter mechanism 23 is not limited to the aforesaid design, other rotary snap design or latch mechanism design can be used as a substitute to achieve the same effects.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A coin acceptor, comprising:
a coin acceptor main unit comprising a first holder shell, a second holder shell, a coin passage defined between said first holder shell and said second holder shell, a coin outlet connected to a rear side of said coin passage, a coin-return passage located at a front side of said coin outlet in communication with said coin passage, and a pivot mechanism pivotally coupling a rear side of said first holder shell to a rear side of said second holder shell; and
a face panel comprising a panel body fastened to a front side of said first holder shell, a coin insertion slot located in said panel body in communication with said coin passage, a coin-return slot located in said panel body in communication with said coin-return passage, a coin-return button mounted at said panel body and pressable by a user to bias said second holder shell relative to said first holder shell for returning an inserted coin, and a limiter mechanism mounted at a back side of said panel body and adapted to limit the basing angle of said second holder shell relative to said first holder shell.

2. The coin acceptor as claimed in claim 1, wherein said coin acceptor main unit further comprises a coin validator, said coin validator comprising a plurality of circuit boards respectively mounted in said first holder shell and said second holder shell and a plurality of induction coils and optical identification devices installed in said circuit boards and adapted to identify the authenticity and value of each inserted coin.

3. The coin acceptor as claimed in claim 1, wherein said pivoting mechanism of said coin acceptor main unit comprises a pivot shaft inserted through at least one pivot holder shell at a rear side of said first holder shell and at least one pivot holder shell at the rear side of said second holder shell to pivotally connect said first holder shell and said second holder shell together, and a torsional spring mounted around said pivot shaft and adapted to impart a pressure to said second holder shell toward said first holder shell and to hold said first holder shell and said second holder shell in a close position.

4. The coin acceptor as claimed in claim 1, wherein said coin acceptor main unit further comprises an electromagnetic valve mounted in said second holder shell, and a gate movable by said electromagnetic valve to close or open said coin outlet.

5. The coin acceptor as claimed in claim 1, wherein said second holder shell of said coin acceptor main unit comprises a bottom bearing portion and an open space defined above said bottom bearing portion; said limiter mechanism of said face panel comprises a longitudinal guide rail affixed to the back side of said panel body, and a sliding block mounted on and movable along said longitudinal guide rail between a constraint position and a release position, said sliding block comprising a protruding stop flange backwardly extended from one lateral side thereof, said protruding stop flange being suspended in said open space of said second holder shell when said limiter mechanism is in said release position, said protruding stop flange being stopped against said bottom bearing portion of said second holder shell when said limiter mechanism is in said constraint position.

6. The coin acceptor as claimed in claim 5, wherein said longitudinal guide rail comprises two coupling grooves longitudinally located at two opposite lateral sides thereof; said sliding block comprises two coupling flanges respectively and slidably coupled to said coupling grooves of said longitudinal guide rail.

7. The coin acceptor as claimed in claim 1, wherein said coin-return button comprises a plunger for biasing said second holder shell; said face panel further comprises an accommodation chamber defined in said panel body between said coin insertion slot and said coin-return slot for accommodating said coin-return button, a through hole located in said accommodation chamber for the passing of said plunger of said coin-return button, a back partition plate perpendicularly backwardly extended from said panel body adjacent to one side of said coin insertion slot coin-return button and inserted in between said first holder shell and said second holder shell of said coin acceptor main unit, and an elastic member mounted around said plunger and stopped between said coin-return button and said accommodation chamber.

8. The coin acceptor as claimed in claim 1, wherein said limiter mechanism of said face panel comprises a longitudinal guide rail affixed to the back side of said panel body, and a sliding block mounted on and movable along said longitudinal guide rail, said sliding block comprising a protruding stop flange backwardly extended from one lateral side thereof movable with said sliding block between a constraint position to limit the biasing angle of said second holder shell relative to said first holder shell and a release position for allowing said second holder shell to be freely biased relative to said first holder shell.

9. The coin acceptor as claimed in claim 8, wherein said longitudinal guide rail comprises two coupling grooves longitudinally located at two opposite lateral sides thereof; said sliding block comprises two coupling flanges respectively and slidably coupled to said coupling grooves of said longitudinal guide rail.

10. The coin acceptor as claimed in claim 9, wherein said longitudinal guide rail further comprises a flat narrow guide rail plate located at a front side thereof between said two coupling grooves, and a plurality of raised portions located upper and lower sides of an outer edge of said flat narrow guide rail plate; said sliding block further comprises a sliding slot coupled to and movable along said longitudinal guide rail, a sliding groove longitudinally located in an inner side of said sliding slot and coupled to and movable along said flat narrow guide rail plate, and a plurality of retaining holes located in said sliding groove for selectively receiving the raised portions at the lower or upper side of said outer edge of said flat narrow guide rail plate to keep said sliding block in one of said constraint position and said release position.
